(19) United States
(12) Patent Application Publication
(10) Pub. No.: US 2006/0151637 A1
(43) Pub. Date: Jul. 13, 2006

(54) Injection valve

(76) Inventors: Edgar Schneider, Knetzgau (DE); Thomas Koeppel, Suzhou Jiungsu (CN)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/533,308

(22) PCT Filed: Aug. 11, 2003
(86) PCT No.: PCT/DE03/02704

§ 371 Date: Nov. 16, 2005

(30) Foreign Application Priority Data
Oct. 31, 2002 (DE) 102 50 720.1

(51) Int. Cl. F02M 63/00

(52) U.S. Cl. 239/533.2

(57) ABSTRACT

An injection valve with a valve control module (2) adjacent to a nozzle module with a nozzle plate has a nozzle needle axially movable in a nozzle body. An intermediate element is pressed against the throttle plate by a spring disposed between the intermediate element and the nozzle needle and exerts an axial force on the nozzle needle in the closing direction. At least one outlet throttle is provided in the throttle plate, and at least one inlet throttle connected to a high-pressure region is provided, both of which throttles feed into a valve control chamber. The throttle plate has an enclosed raised area that delimits an inner chamber, constitutes a delimitation for the valve control chamber, and contains the inlet throttle.

### PRIOR ART

The invention relates to an injection valve with a valve control module and a nozzle module, of the type generically defined by the preamble to claim 1.

Injection valves of this kind are sufficiently known from the prior art and are particularly used in connection with common rail injection systems for diesel internal combustion engines.

An injection valve of the above-mentioned type known from the prior art has a nozzle body of a nozzle module, which contains a nozzle needle that can move in the axial direction in order to open and close the injection valve. At its end oriented toward the combustion chamber of the internal combustion engine, the nozzle body is provided with a number of injection openings that can be controlled by means of the axially mobile nozzle needle. In addition, the injection valve is embodied with a valve control module that has a module housing and piezoelectric actuator module provided therein, which are operationally connected to the nozzle module via a valve control chamber in an intrinsically known manner.

The piezoelectric actuator module is adjoined by a valve element mechanism that transmits an adjustment path of the piezoelectric actuator module to a valve closing element. The valve element mechanism has a first piston, a so-called adjusting piston, and a second piston, a so-called actuating piston, between which is provided a hydraulic transmission device or hydraulic coupler. The hydraulic coupler also serves to compensate for differences in axial length caused by temperature differences.

The valve control module controls the nozzle needle by means of pressure changes in the so-called valve control chamber; the pressure changes in the valve control chamber trigger an axial movement of the nozzle needle, which in turn opens or closes the injection openings of the nozzle body leading to the combustion chamber of the engine.

The pressure in the valve control chamber is set by means of two throttles feeding into the valve control chamber, an outlet throttle disposed in a throttle plate and an inlet throttle disposed in a sleeve that delimits the valve control chamber and encompasses the nozzle needle.

However, a disadvantage to this is that the tolerance ranges required for a proper operation of the injection valve, in particular those in the balancing of a diameter ratio between the inlet throttle and the outlet throttle as a function of an opening pressure of the injection pressure in the valve control chamber, can only be achieved by means of a very costly testing and a high degree of complexity in terms of production engineering, which incur high technical and apparatus-related expenditures.

The object of the current invention, therefore, is to provide an injection valve that is easy and inexpensive to produce.

According to the invention, this object is attained with an injection valve according to the features of claim 1.

### ADVANTAGES OF THE INVENTION

The injection valve according to the invention, with the features according to the preamble of claim 1, in which the side of the throttle plate oriented toward the nozzle module has an enclosed raised area, which not only delimits an inner chamber, but also represents a boundary for the valve control chamber and contains the inlet throttle, has the advantage that the outlet throttle and the inlet throttle are integrated into a single component, i.e. the throttle plate, which makes it considerably easier to balance the diameter ratio of a diameter of the outlet throttle and a diameter of the inlet throttle as a function of an injection valve opening pressure in the valve control chamber.

In particular, it is possible to keep in store a selection of different throttle plates that are classed according to the diameter ratio or according to the ratio between the throttling action of the outlet throttle and the throttling action of the inlet throttle and, as a function of an empirically determined opening pressure of a nozzle module, to select from among the classed throttle plates a throttle plate that “fits” and to pair it with this nozzle module.

Consequently, during the assembly of an injection valve, a balancing is carried out between the opening pressure of the nozzle module and the ratio between the throttling actions of the two throttles of the valve control chamber; this balancing, which is necessary for the desired function of the injection valve, is carried out in a simple manner through the measurement of the opening pressure by a measuring device and the definite pairing with a component, i.e. the throttle plate.

Throttle plates or throttles disks of this kind, which are produced at the same time as the inlet throttle and the outlet throttle for the valve control chamber, are advantageously produced in one continuous segment of a production line.

In comparison to injection valves known from the prior art, an injection valve according to the invention also has the advantage that a balancing with regard to the diameter ratio between the diameter of the inlet throttle and the diameter of the outlet throttle is carried out with only a single component.

It is also advantageous that the placement of the inlet throttle in the region of the raised area of the throttle plate does not result in any significant change in the position of the inlet throttle as compared to an injection valve known from the prior art, which means that in order to obtain an injection valve according to the invention, a known structural embodiment of an injection valve need only be provided with a throttle plate embodied according to the invention and with an intermediate element that is adapted to the throttle plate according to the invention.

Other advantages and advantageous modifications of the subject of the invention ensue from the specification, the drawings, and the claims.

### DRAWINGS

An exemplary embodiment of the injection valve according to the invention is shown in schematically simplified fashion in the drawings and will be explained in detail in the subsequent description.

FIG. 1 shows a schematic longitudinal section through part of an injection valve, and

FIG. 2 shows an enlarged detail X of the injection valve according to FIG. 1.

### DESCRIPTION OF THE EXEMPLARY EMBODIMENT

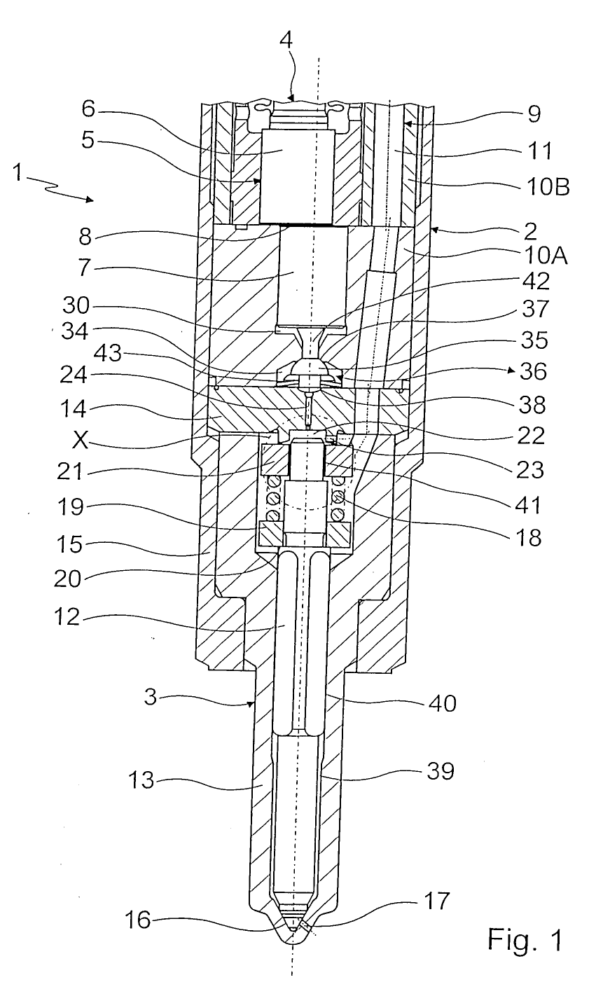

FIG. 1 shows an injection valve 1 with a valve control module 2 and a nozzle module 3. The valve control module 2 is embodied with an actuator module 4 that is depicted only partially; the actuator module 4 is a piezoelectric actuator unit. The actuator module 4 is adjoined by a valve element mechanism 5, which has an adjusting piston 6 and an actuating piston 7; between these two pistons 6, 7, a hydraulic chamber 8 is provided, which functions as a hydraulic coupler or hydraulic transmission and as a compensation element for temperature-induced fluctuations in length of the injection valve 1.

In addition, the injection valve 1 is embodied with a high-pressure region and a high-pressure connection 9, via which a conduit 11 extending in components 10A, 10B of the valve control module 2 is supplied with fuel at high common rail pressure, which is then supplied to the nozzle module 3; the common rail pressure can be up to 1.6 kbar.

The injection valve 1 in this case is provided in an intrinsically known manner with a pressure-control valve, not shown in detail, that is used to set a system pressure of a low-pressure region 30 of the injection valve 1. The system pressure of the injection valve 1 is preferably less than 30 bar and, depending on the current intended use, the pressure-control valve sets the level of the system pressure to a required value that has a positive effect on the operation of the injection valve.

The nozzle module 3 is embodied with a nozzle needle 12 that is disposed so that it can move axially in a nozzle body 13. According to the depiction in FIG. 1, the nozzle body 13 rests against a throttle plate 14 of the valve control module 2 and is attached to the valve control module 2 by means of a nozzle coupling nut 15.

At its end oriented away from the valve control module 2, the nozzle needle 12 cooperates with a valve seat 16 of the nozzle body 13 so that when the nozzle needle 12 lifts away from the valve seat 16, injection openings 17 of the nozzle body 13 are opened and fuel is injected into a combustion chamber of an internal combustion engine.

During the injection event, the nozzle needle 12 in the nozzle body 13 moves from the valve seat 16 toward the valve control module 2 and valve plate 14 counter to a spring force of a spring 18 that acts on the nozzle needle 12 in the closing direction of the nozzle needle 12.

The end of the spring 18 oriented away from the valve control module 2 is supported by means of a disk 19 against a shoulder 20 of the nozzle needle 12. At its end oriented toward the valve control module 2, the spring 18 rests against an intermediate element or a so-called spring plate 21, which in turn rests against the throttle plate 14. The thickness of the disk 19 can be used to influence the behavior of the spring 18, thus allowing manufacturing tolerances to be compensated for during assembly of the injection valve 1 by making a definite choice from among the classed disks 19 kept in store.

The nozzle needle 12, the spring plate 21, and the throttle plate 14 delimit a valve control chamber 22, which in this instance, communicates with a respective inlet throttle 23 and outlet throttle 24 that are both disposed in the throttle plate 14.

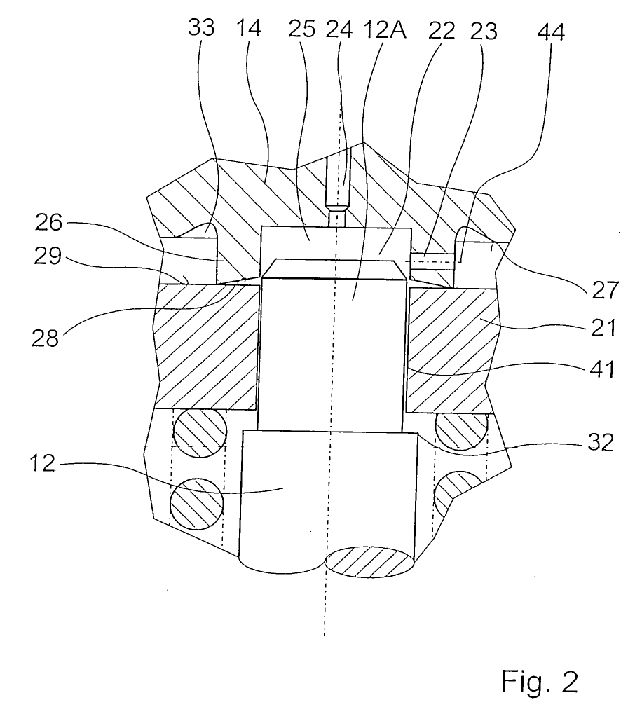

FIG. 2 shows an enlarged view of the region of the injection valve 1 labeled X in FIG. 1. In the region X, the side of the throttle plate 14 oriented toward the nozzle module 3 has an enclosed, circumferential raised area 26 that delimits an inner chamber 25 and, together with the spring plate 21 and an end region 12A of the nozzle needle 12, delimits the valve control chamber 22. In this instance, the raised area is embodied as an annular collar 26 that extends toward the spring 18 and protrudes beyond an end surface 27 of the throttle plate 14 oriented toward the nozzle module 3.

In the sectional view shown in FIG. 2, the inlet throttle 23 is disposed in the annular collar 26 as a result of which the high-pressure region 9 of the injection valve 1 that encompasses the spring plate 21 is connected to the valve control chamber 22 by means of the inlet throttle 23. In addition, the outlet throttle 24 extends away from the valve control chamber 22, i.e. from the inner chamber 25 of the annular collar 26, in the direction of the low-pressure region 30 of the injection valve 1.

A minimal distance from a center line 44 of the inlet throttle 23 in the annular collar 26 to the end surface 27 of the throttle plate 14 should not be less than 2 mm in order to provide enough space for an electrode guide during the erosion used to produce the inlet throttle 23 in the annular collar 26. The diameter of the inlet throttle 23 preferably lies in a range from 0.15 to 0.25 mm; in the current instance, the inlet throttle has a diameter of 0.2 mm.

An end surface 28 of the annular collar 26 oriented toward the spring plate 21 has a conically embodied cross-section in relation to a surface 29 of the spring plate 21 oriented toward the throttle plate 14 so that when the spring plate 21 contacts the annular collar 26, there is a linear contact between these two components, which is particularly advantageous for producing a seal between the valve control chamber 21 and the high-pressure region 8. The contact between the spring plate 21 and the annular collar 26 is produced by the spring 18, whose prestressed installation position causes it to press the spring plate 21 against the annular collar 26.

The end region 12A of the nozzle needle 12, which is guided so that it can move axially in a guide 41 of the spring plate 21, is embodied with a smaller diameter than a region of the nozzle needle 12 disposed outside the spring plate and encompassed by the spring 18. This stepping of the nozzle needle 12 on the side of the spring plate 21 oriented away from the throttle plate 14 forms a shoulder 32, which constitutes a stroke path limitation for the nozzle needle 12 when this nozzle needle 12 moves in the opening direction of the nozzle module 3 and injection valve 1.

At a transition between the annular collar 26 and the end surface 27 of the throttle plate 14, the end surface 27 of the throttle plate 14 is embodied with a recess 33, which is provided among other things so that the end surface 27 of the throttle plate 14 can be machined with a grinding tool even in the region close to the annular collar 26.

The operation of the exemplary embodiment of an injection valve shown in FIG. 1 will be described below in connection with its use in a fuel injection valve for internal combustion engines of motor vehicles; the fuel injection valve or injection valve 1 in the current embodiment is designed as a common rail injector.

In order to set an injection start, an injection duration, and an injection quantity by means of fuel ratios in the fuel injection valve 1, the valve element mechanism 5 is triggered by means of the actuator module 4, which is disposed at the end of the valve element mechanism 5 oriented toward the valve control chamber and away from the combustion chamber. The piezoelectric actuator of the actuator module 4, not shown in detail, is composed of a number of ceramic layers in an intrinsically known fashion and has an actuator head 42 at its end oriented toward the valve element mechanism 5 and, at its end oriented away from the valve element mechanism 5, has an actuator base, not shown, which is supported against a wall of a valve housing of the injection valve 1.

In the position of the valve element mechanism 5 shown in FIG. 1, a control chamber 34 of the injection valve 1 is shut off from the low-pressure region 30. The control chamber 34 contains a valve element 35 of a control valve 36, which, when the actuator module 4 is without current, rests in a sealed fashion against a first control valve seat 37 that is embodied in the component 10A of the valve control module 2. The connection between the control chamber 34 and the valve control chamber 22 via the outlet throttle 24 is open because the valve element 35 is pressed against the first control valve seat 37 by a spring mechanism and by the pressure prevailing in the control chamber 34. In this position of the valve element 35, the piezoelectric actuator is without current and the injection valve 1 is closed by the contact of the nozzle needle 12 against the valve seat 16 of the nozzle body 13.

If the actuator module 4, i.e. its piezoelectric ceramic, is supplied with current, then the length of the piezoelectric ceramic increases due to the piezoelectric effect. This lengthening is transmitted in an intrinsically known manner from the valve element mechanism to the valve element 35 so that the valve element 35 is lifted away from the first control valve seat 37 and slid axially toward a second control valve seat 38 embodied on the side of the throttle plate 14 oriented toward the control chamber 34.

In this position of the valve element 35, the high-pressure region 9 is connected to the low-pressure region 30 via the valve control chamber 22 and the control chamber 34, and the pressure of the valve control chamber 22 is relieved in the direction of the low-pressure region 30 via the outlet throttle 24. The ratios of pressure and surface area in the nozzle module 3 cause the nozzle needle 12 to lift away from the valve seat 16 of the nozzle body 13.

In order to close the injection valve 1, the valve element 35 is placed in a sealed fashion against the first control valve seat 37 or the second control valve seat 38, thus closing the connection between the valve control chamber 22 and the low-pressure region 30. In order to place the valve element 35 in a sealed fashion against the first control valve seat 37, the current supply to the actuator module 4 is interrupted, which cancels the lengthening of the piezoelectric ceramic of the actuator module. This is accompanied by an axial movement of the valve element mechanism 5 toward the actuator module 4 and, as a result of both the pressure in the control chamber 34 and a spring force of a spring element 43 acting on the valve element 35 in the direction of the first control valve seat 37, the valve element 35 is in turn pressed in a sealed fashion against the first control valve seat 37.

In this position of the valve element 35, the connection between the low-pressure region 30 and the valve control chamber 22 is interrupted or closed. As a result, the pressure in the valve control chamber 22 rises via the inlet throttle 23, approaching the pressure in the high-pressure region 9; starting from a definite pressure value in the valve control chamber 22, the nozzle needle 12 is pressed against the valve seat 16 of the nozzle body 13 in a sealed fashion, thus closing the injection valve 1 and its injection openings 17.

The second position of the valve element 35 described above, which causes the injection valve 1 to close, is achieved by setting a current supply of the actuator module 4 in such a way that the lengthening of the actuator module 4 causes a sealing contact of the valve element 35 against the second control valve seat 38 and the valve element 35 closes the outlet throttle 24. As a result, the connection is simultaneously closed between the valve control chamber 22 and the low-pressure region 30 so that the pressure in the valve control chamber 22 increases via the inlet throttle 23, thus causing the injection valve 1 to close in the above-described manner.

The closing of the injection valve 1 through contact of the valve element 35 against the first control valve seat 37 is preferable if an injection phase into a combustion chamber of an engine has finished and the intent is for no further injections to occur during this injection phase.

The closing of the injection valve 1 through contact of the valve element 35 against the second control valve seat 37 is preferable during an injection phase that is comprised of a number of injections in rapid succession. This is due to the fact that the valve element 35 does not have to be moved in opposition to the high-pressure of the valve control chamber 22 in order to open the injection valve 1, as it does when lifting away from the first control valve seat 37; instead, the high pressure in the valve control chamber 22 and the spring force of the spring element 43 both encourage the opening the connection between the valve control chamber 22 and the control chamber 34 when the current supply to the actuator module 4 is reduced.

The nozzle needle 12 is guided in a sealed, longitudinally mobile fashion in a guide 40 of the nozzle body 13 and in the guide 41 of the spring plate 21; the two guides 40 and 41 are matched to each other in order to prevent the axial movement of the nozzle needle 12 due to a possibly incorrect position of the nozzle needle 12 that would lead to increased frictional forces between the nozzle needle 12 and the nozzle body 13 and spring plate 21. In particular, the guide 41 of the spring plate 21 is embodied as relatively short in the axial direction of the injection valve 1, which offers a production cost advantage over the sleeve-like components embodied with longer guide regions known from the prior art.

The throttle plate 14 with the inlet throttle 23 and outlet throttle 24 is a prefabricated, classed disk, which is embodied with a definite diameter ratio between a diameter of the inlet throttle 23 and a diameter of the outlet throttle 24 that assures a proper operation of the injection valve 1 for a particular opening pressure of the injection valve 1. The so-called opening pressure here is the pressure value in the valve control chamber 22 with an open control valve 36 at which the nozzle needle 12 lifts away from the valve seat 16 of the nozzle body 13.

In the injection valve according to the invention, it is therefore possible to use an opening pressure of the nozzle module 3 and/or injection valve 1 measured in a special measuring apparatus in order to select a throttle plate with the ratio that is required for a proper operation of the injection valve 1, i.e. the diameter ratio between a diameter of the inlet throttle and a diameter of the outlet throttle and/or the ratio between the throttling actions of the inlet throttle 23 and outlet throttle 24. Because of manufacturing tolerances, this diameter ratio or ratio between the throttling actions of the two throttles differs from nozzle module to nozzle module. This is why an assembly process includes storing a selection of classed throttle disks with different diameter ratios and pairing them with a nozzle module as a function of the opening pressure.

Throttle plates of this kind can be produced easily and inexpensively since the inlet throttle and outlet throttle are integrated into one work piece or a single component. In addition, this significantly simplifies the adjustment of an injection valve during assembly.

For example, the operation of an injection valve can be adjusted by the pairing of throttle plates whose inlet throttles have a flow that is selected as a function of the determined opening pressure and is suitable for a proper operation of the injection valve. The diameter of the outlet throttle is adapted to the diameter of the inlet throttle so that the diameter ratio of the throttles is constant in all throttle plates to be paired.

In addition, it is naturally also possible to adjust the operation of injection valves by means of throttle plates with varying diameter ratios. The diameter ratio of the classed throttle disks is varied either by changing the diameter of the inlet throttle, by changing the diameter of the outlet throttle, or by changing the diameter of both the inlet and outlet throttle.

A minimal distance from a center line of the inlet throttle 23 in the annular collar 26 to the end surface 27 of the throttle plate 14 should not be less than 2 mm in order to leave enough room for an electrode guide during erosion. The diameter of the inlet throttle lies in a range from 0.15 to 0.25 mm and, in the current instance, preferably has a diameter of 0.2 mm.

In another embodiment of the injection valve that differs from the above-described embodiment, the raised area of the throttle plate positively engages in at least some areas with a device of the nozzle module to permit radial adjustment of the valve control module in relation to the nozzle module. This results in the advantageous possibility of eliminating the centering pins preferably used in injection valves known from the prior art to center the valve control module in relation to the nozzle module in the region between the throttle plate and the nozzle body of the nozzle module, and replacing them with the raised area, which advantageously reduces the number of parts of an injection valve, which in turn simplifies assembly.

1-10. (canceled)

11. In an injection valve (1) with a valve control module (2) and an attached nozzle module (3), which has a nozzle needle (12) that is disposed so that it can move axially in a nozzle body (13), wherein the valve control module (2) adjoins the nozzle module (3) with a throttle plate (14) and, in the region of an end of the nozzle needle (12) oriented toward the throttle plate (14), an intermediate element (21) is provided, which is pressed against the throttle plate (14) by means of a spring (18) that is disposed between the intermediate element (21) and the nozzle needle (12) and exerts an axial force on the nozzle needle (12) in the closing direction, wherein at least one outlet throttle (24) is provided in the throttle plate (14) and at least one inlet throttle (23) connected to a high-pressure region (9) is provided, both of which throttles feed into a valve control chamber (22), the improvement wherein, on its side oriented toward the nozzle module (3), the throttle plate (14) has an enclosed raised area (26) that delimits an inner chamber (25), constitutes a delimitation for the valve control chamber (22), and contains the inlet throttle (23).

12. The injection valve according to claim 11, wherein the intermediate element (21) is embodied as a spring plate, which rests against the end surface (28) of the raised area (26) on the throttle plate (14) oriented toward the nozzle module (3).

13. The injection valve according to claim 11, wherein the nozzle needle (12) of the nozzle module (3) is guided in a guide (41) of the intermediate element (21) and when the nozzle module (3) opens, moves axially in the guide (41) of the intermediate element (21) so that the end (12A) of the nozzle needle (12) oriented toward the throttle plate (14) engages in an inner chamber (25) of the raised area (26).

14. The injection valve according to claim 12, wherein the nozzle needle (12) of the nozzle module (3) is guided in a guide (41) of the intermediate element (21) and when the nozzle module (3) opens, moves axially in the guide (41) of the intermediate element (21) so that the end (12A) of the nozzle needle (12) oriented toward the throttle plate (14) engages in an inner chamber (25) of the raised area (26).

15. The injection valve according to claim 11, wherein, in the region of the intermediate element (21), the nozzle needle (12) has a shoulder (32), which, upon execution of a definite stroke path of the nozzle needle (12) during an axial movement of the nozzle needle (12) to open the nozzle module (3), comes to rest against the side of the intermediate element (21) oriented away from the throttle plate (14).

16. The injection valve according to claim 12, wherein, in the region of the intermediate element (21), the nozzle needle (12) has a shoulder (32), which, upon execution of a definite stroke path of the nozzle needle (12) during an axial movement of the nozzle needle (12) to open the nozzle module (3), comes to rest against the side of the intermediate element (21) oriented away from the throttle plate (14).

17. The injection valve according to claim 13, wherein, in the region of the intermediate element (21), the nozzle needle (12) has a shoulder (32), which, upon execution of a definite stroke path of the nozzle needle (12) during an axial movement of the nozzle needle (12) to open the nozzle module (3), comes to rest against the side of the intermediate element (21) oriented away from the throttle plate (14).

18. The injection valve according to claim 11, wherein the end surface (28) of the raised area (26) oriented toward the intermediate element (21) is embodied with a conical cross section so that a linear contact is produced between the raised area (26) and the intermediate element (21).

19. The injection valve according to claim 12, wherein the end surface (28) of the raised area (26) oriented toward the intermediate element (21) is embodied with a conical cross section so that a linear contact is produced between the raised area (26) and the intermediate element (21).

20. The injection valve according to claim 13, wherein the end surface (28) of the raised area (26) oriented toward the intermediate element (21) is embodied with a conical cross section so that a linear contact is produced between the raised area (26) and the intermediate element (21).

21. The injection valve according to claim 15, wherein the end surface (28) of the raised area (26) oriented toward the intermediate element (21) is embodied with a conical cross section so that a linear contact is produced between the raised area (26) and the intermediate element (21).

22. The injection valve according to claim 11, further comprising a disk (19) for adjusting a spring force of the spring (18) between an end of the spring (18) oriented away from the throttle plate (14) and a shoulder (20) of the nozzle needle (12).

23. The injection valve according to claim 12, further comprising a disk (19) for adjusting a spring force of the spring (18) between an end of the spring (18) oriented away from the throttle plate (14) and a shoulder (20) of the nozzle needle (12).

24. The injection valve according to claim 13, further comprising a disk (19) for adjusting a spring force of the spring (18) between an end of the spring (18) oriented away from the throttle plate (14) and a shoulder (20) of the nozzle needle (12).

25. The injection valve according to claim 18, further comprising a disk (19) for adjusting a spring force of the spring (18) between an end of the spring (18) oriented away from the throttle plate (14) and a shoulder (20) of the nozzle needle (12).

26. The injection valve according to claim 11, further comprising a recess (13) in the throttle plate (14) at a transition between the raised area (26) and an end surface (27) of the throttle plate (14) oriented toward the intermediate element (21).

27. The injection valve according to claim 13, wherein the guide (41) of the intermediate element (21) for the nozzle needle (12) is matched to a guide (40) of the nozzle body (13) of the nozzle module (3) for the nozzle needle (12).

28. The injection valve according to claim 11, wherein a ratio is set between a diameter of the outlet throttle (24) and a diameter of the inlet throttle (23) as a function of a pressure in the valve control chamber (22) at which the nozzle module (3) opens.

29. The injection valve according to claim 12, wherein a ratio is set between a diameter of the outlet throttle (24) and a diameter of the inlet throttle (23) as a function of a pressure in the valve control chamber (22) at which the nozzle module (3) opens.

30. The injection valve according to claim 11, wherein the raised area of the throttle plate positively engages in at least some areas with a device of the nozzle module to permit radial adjustment of the control module in relation to the nozzle module.
